(19) United States
(12) Patent Application Publication
(10) Pub. No.: US 2019/0124865 A1
(43) Pub. Date: May 2, 2019

(54) APPARATUS AND METHOD FOR INACTIVATING PLANT PATHOGENS WHILE STIMULATING PLANT GROWTH VIA SELECTIVE APPLICATION OF OXYGEN/OZONE GAS MIXTURES, AND CARBON DIOXIDE, IN A MULTI COMPARTMENT SYSTEM

(71) Applicant: Gerard V. Sunnen, New York, NY (US)

(72) Inventor: Gerard V. Sunnen, New York, NY (US)

(21) Appl. No.: 16/170,431

(22) Filed: Oct. 25, 2018

Related U.S. Application Data
(60) Provisional application No. 62/707,275, filed on Oct. 27, 2017.

(51) Int. Cl. A01G 31/02; A01G 9/20; A01G 7/02; A01G 29/00; A01G 7/06; A01G 9/24

(52) U.S. Cl. CPC A01G 31/02; A01G 9/20; A01G 9/246; A01G 29/00; A01G 7/06; A01G 7/02

(57) ABSTRACT

In accordance with one embodiment, a system for a plant culture to promote plant growth while concomitantly providing microbial protection including a main housing having a hollow interior which is divided into a first compartment and a second compartment by a membrane that extends across the hollow interior of the main housing. The membrane provides a fluid barrier between the first compartment and the second compartment. The first compartment receives foliage of the plant and the second compartment receives a lower stem and roots of the plant.

### CROSS REFERENCE TO RELATED APPLICATION

The present application claims priority to and the benefit of U.S. patent application Ser. No. 62/707,275, filed Oct. 27, 2017, which is hereby incorporated by reference in its entirety.

### TECHNICAL FIELD

The present application is directed to the treatment of plant pathogens and more particularly to a system and method for treating and inactivating plant pathogens, while stimulating plant growth via selective application of oxygen/ozone gas mixtures and carbon dioxide.

### BACKGROUND

A perennial problem plaguing plant health concerns their contamination with fungal and bacterial organisms, protozoans and insects. This is especially concerning if the plants are food crops, or are destined to become medicinal ingredients. Insecticides, fungicides and other antimicrobials inhibit microbial pathogens, but unfortunately leave chemical residues that, when ingested, make them insalubrious, toxic, and even deadly. Without the use of these agents, however, pathogens can overwhelm crops, leading to poor yields, or demise.

The present invention is directed to a method and system that overcome these deficiencies and provide a positive plant growth environment in which plant health is maintained and the plants can prosper and grow, while pathogens are rendered inactive.

### SUMMARY

In accordance with one embodiment, a system for a plant culture to promote plant growth while concomitantly providing microbial protection including a main housing having a hollow interior which is divided into a first compartment and a second compartment by a membrane that extends across the hollow interior of the main housing. The membrane provides a fluid barrier between the first compartment and the second compartment. The first compartment receives foliage of the plant and the second compartment receives a lower stem and roots of the plant.

One or more elastic sleeves are defined in an opening formed in the membrane for receiving the stem of the plant. The sleeve can be integral to the membrane.

A first fluid source is in selective communication with the first compartment for providing the first fluid to the first compartment. The first fluid being a fluid that promotes plant growth and is preferably carbon dioxide.

A second fluid source is in selective communication with the second compartment for providing the second fluid to the second compartment. The second fluid is a fluid that renders plant pathogens inactive and is preferably ozone.

A controllable valve is positioned along the membrane for selectively communicating the second compartment to the first compartment as when a spike treatment is required in the first compartment to treat against a pathogen outbreak.

### BRIEF DESCRIPTION OF THE DRAWING FIGURES

FIG. 1 is a schematic of a system in accordance with one exemplary embodiment; and

FIG. 2 is a schematic showing a computer implementation of the system of FIG. 1.

### DETAILED DESCRIPTION OF CERTAIN EMBODIMENTS

In accordance with the present invention, an apparatus and a method are provided for fungal, bacterial, viral, and insect and protozoan decontamination of cultured plants, including herbs and spices, in a process that leaves no chemical residues, thus ensuring the plants' purity. Concomitantly, this invention allows for the simultaneous application of plant growth enhancers, such as, but not limited to, carbon dioxide (CO2). Ambient carbon dioxide is known to increase plant growth as it is part of a photosynthesis process.

Cultured plants requiring highest purity are especially concerned by this invention because they need to achieve medical grade standards. Examples of medicinal plants are willow, for the culture of natural aspirin, cinchona (quinine), and medical cannabis, among many others.

The process described herewith can be applied to any number of cultured plants, from a few shoots, to large tended enclosed plantations. While the examples cited pertain to the cultivation of medicinal cannabis, the principles of enhanced plant growth combined with microbial disinfection and insect decontamination applies to all plants under culture destined for human or animal consumption.

In this invention, as described in more detail below, plants under culture are divided so that their foliage is contained in an upper compartment, and their trunks are sequestered in another, lower compartment. This separation is achieved by means of a horizontal membrane that surrounds the plant trunks by means of a fitted elastic skirt. Thus, the upper parts of the plants, namely their foliage, is separated from their lower part, comprising their stems or trunks, the soil or nutrient medium, and the plant roots.

A third compartment contains the nutrient medium, which may be soil-based, or aqueous in nature. This undermost compartment, which may be hydroponic, is calibrated, not only in its nutrient composition, but also in its dissolved gas component. Dissolved gases may include oxygen, which stimulates root function, and ozone, which is used for microbial control.

The invention therefore can be a three-compartment system for growing plants, with one upper chamber bathing the foliage part of the plants, a lower compartment containing the plant stems, and a third, containing the root system. To the upper foliage compartment are added gaseous nutrients whose purpose is to stimulate plant growth, such as, but not limited to carbon dioxide, CO2.

The lower compartment, containing stems, is infused with oxygen/ozone gas mixtures that, in their selected proportional concentrations, are designed to exert comprehensive anti-microbial actions. Indeed, ozone has gathered extensive data in the scientific literature to support its activity against a wide range of bacteria, fungi, viruses and parasites.

Under selected circumstances, various reactive oxygen species (ROS) may be added to this middle compartment—such as any of the peroxides; or nitrogen reactive species (NRS), all designed to further enhance antimicrobial capacities. Selective humidification of this compartment is an added component, as water chemically interacts with these gases to produce anti-microbial transitional compounds, such as peroxide species.

A shock treatment can be selectively implemented. At times, in situations that resemble the treatment of swimming pools that become overrun with pathogens and are treated with a one-time massive dose of chlorine, the foliage growth compartment may need to be “shocked” when it is determined that invading organisms are threatening homeostasis. In this scenario, the foliage chamber is infused with the ozone/oxygen milieu of the upper foliage compartment via the opening of a communication valve in the membrane.

All of the gaseous contributions to these compartments have one common denominator: They are devoid of any chemical residues because, in their degradation, they all revert to elemental atmospheric components, namely oxygen, water, carbon dioxide and nitrogen. Ozone, in a gaseous milieu, for example, naturally reverts to pure oxygen, at the rate of about 50% per hour at room temperature.

The lower part of the plants, comprising the stems, is walled-off by a membrane. In this middle chamber is circulated an oxygen/ozone gas mixture of selected concentration, capable of inhibiting microbial growth. In the example of medical cannabis, the most worrisome invaders responsible for most loss of crops are fungi. Ozone, here, is recruited for its disinfecting properties, used around the world in municipal waterworks.

After the plants are harvested and dried, they may be placed in an auxiliary chamber that mimics the conditions of the ozone/oxygen chamber. Placing crop foliage in the auxiliary chamber for prescribed time spans is a further step in quality control, as the disinfecting gaseous mixture inactivates any microbe that may be present. This method may also be applied to the comprehensive disinfection of dried herbs and spices. As described below, this auxiliary chamber can easily be integrated into the present apparatus.

As mentioned herein, there are a number of challenges to growing plants including but not limited to pathogens such as the ones described below.

Plant Diseases

Diseases affecting plants cause massive losses in crop yields yearly. It is estimated that up to 85% of botanical diseases involving crops for human consumption have fungal etiologies. Other causes, comprising bacterial and viral organisms, however, remain massive threats to plant health. To illustrate how this proposed invention addresses plant diseases in general, the example of cannabis medicinal cultivation is presented.

Molds/Fungi in cannabis

Fungal diseases are by far the most important pathogens threatening cannabis cultures. Numerous fungal families are capable of infecting, and often eradicating them.

The list of cannabis fungal pathogens is long, and only a few are cited herewith: Anthracnoses, Black mildew, Charcoal rot, Cylindrosporium blight, powdery mildew, Botrylis or grey mold, Fusarium, Pythium or root fungi, Altenaria, Phomopsis stem canker, rust, White and yellow leaf spot Rhizoctonia root rot.

Other fungal families inhibited and destroyed by exposure to ozone include Candida, Aspergillus, Histoplasma, Actinomycoses, and Cryptococcus

All these fungi species are susceptible to ozone inactivation. Ozone traverses their mycelium walls with ease, and once in their intracellular space, disrupts fungal organelles by denaturing their proteins and lipids. The cell walls of fungi are multilayered and composed of approximately 80% carbohydrates and 10% proteins and glycoproteins. The presence of many disulfide bonds has been noted, making this a possible site for oxidative inactivation by ozone. At ozone concentrations of 5% by volume, given time, there is inexorable distress to any and all fungal species, leading to their demise.

Bacterial Pathogens in cannabis Cultivation

Several bacterial species regularly infect hemp plants. Once a single plant is invaded, the bacteria can spread rapidly to decimate the entire crop. Common conditions include Bacterial blight caused by Pseudomonas cannabina, Crown gall caused by Agrobacterium tumefaciens, Stritura ulcerosa by Pseudomonas amygdali and Xanthomonas leaf spot by Xanthomonas campestris pv. cannabis.

Ozone's capacity for bacterial inactivation has been studied across their families and forms the basis for ozone's use in municipal water treatment worldwide. Pathogens such as Salmonella, show marked sensitivity to ozone inactivation. Other bacterial organisms susceptible to ozone's disinfecting properties include Streptococci, Staphylococci, Shigella, Legionella, Pseudomonas, Yersinia, Campylobacter, Mycobacteria, Klebsiella, and Escherichia coli. Ozone destroys aerobic, anaerobic and facultative bacteria.

The precise mechanisms of ozone bacterial destruction need elucidation. Bacterial cell envelopes are made of polysaccharides and proteins. In Gram-negative organisms, fatty acid alkyl chains and helical lipoproteins are present. In acid-fast bacteria, such as Mycobacterium tuberculosis, up to one half of the capsule is formed of complex lipids (esterified mycolic acid, in addition to normal fatty acids), and glycolipids (sulfolipids, lipopolysaccharides, mycosides, trehalose mycolates).

The high lipid content of the cell walls of these ubiquitous bacteria may explain their sensitivity, and eventual demise, in the face of ozone exposure. Ozone disrupts their double and triple molecular bonds. Ozone may also penetrate the cellular envelope, directly affecting cytoplasmic integrity.

Bacteria fare poorly when exposed to ozone, a fact appreciated since the 19th century. Ozone is a strong germicide needing only micrograms per liter for measurable action. Ozone, in a concentration of 5% per volume and admixed with oxygen, rapidly inactivates coliform bacteria, staphylococcus aureus, and Aeromonas hydrophilia.

In fact, at these concentrations, given time, ozone essentially inactivates all bacterial species. This holds true for oxygen-dependent aerobic organisms, for oxygen-independent anaerobic bacteria, well known for causing gangrene in mammals, and for facultative species that can go either way. Ozone's universal antibacterial action makes it an agent of choice in the decontamination of materials that are colonized by medleys of microorganisms belonging to a spectrum of families.

An incomplete list of bacterial families susceptible to ozone inactivation includes: The Enterobacteriaceae, a large group of microorganism families whose natural habitat is the intestinal tract of humans. These Gram-negative organisms include Escherichia coli, Salmonella, Enterobacter, Shigella, Klebsiella, Serratia, and Proteus. Other ozone-sensitive bacterial species include Streptococci, Staphylococci, Legionella, Pseudomonas, Yersinia, Campylobacteri, and Mycobacteria.

The cell envelopes of bacteria are composed of intricate multilayers. Covering the bacterial cytoplasm to form the innermost layer of the envelope is the cytoplasmic membrane, made of phospholipids and proteins. Next, a polymeric layer built with giant peptidoglycan molecules provides bacteria with a stable architecture. In Gram-positive organisms, the pepticoglycan shell is thick and rigid. By contrast, Gram-negative bacteria possess a thin pepticoglycan lamella on which is superimposed an outer membrane made of lipoproteins and lipopolysaccharides.

The most cited explanation for ozone's bactericidal effects centers on disruption of cell membrane integrity through oxidation of its phospholipids and lipoproteins. There is evidence for interaction with proteins as well. In one study exploring the effect of ozone on E. coli, evidence was also found for ozone's penetration through the cell membrane, reacting with cytoplasmic contents, and converting the closed circular plasmid DNA to open circular DNA, which would presumably diminish the efficiency of bacterial procreation. Capsular polysaccharides may be possible sites for ozone action.

All bacterial species infecting hemp plants are systematically eradicated under ambient oxygen/ozone, administered in adequate concentration and duration.

Viruses Infecting Hemp Cultures

Plant viruses that affect all cultivated crops include about 73 genera and 49 families. The universe of plant viruses is, however, much greater. Viral infections of cannabis plants result in leaves that are mottled, discolored, wilting, and stunted growth. Common viruses plaguing cannabis cultures include the Tobacco mosaic virus, the Hemp mosaic virus, the Hemp streak virus, the Arabis mosaic virus, and the Alfalfa mosaic virus known to be carried by aphids, the Cucumber mosaic virus, and the Tomato ringspot virus.

Most research efforts on ozone's virucidal effects have centered upon ozone's propensity to splice lipid molecules at sites of viral multiple bond configurations. Indeed, once the lipid envelope of the virus is fragmented, its DNA or RNA core cannot survive.

Non-enveloped viruses, Adenoviridae, Picornaviridae (poliovirus), Coxsachie, Echovirus, Rhinovirus, Hepatitis A, D, and E, and Reoviridae (Rotavirus), have also been studied in relation to ozone inactivation. Viruses that do not have an envelope are called “naked viruses.” They are constituted of a nucleic acid core (made of DNA or RNA) and a nucleic acid coat, or capsid, made of protein. Ozone, however, aside from its well-recognized action upon unsaturated lipids, can interact with viral proteins and amino acids. Indeed, when ozone comes in contact with capsid proteins, protein hydroxides and protein hydroperoxides are formed.

All viruses, including plant viruses, are devoid of protection against oxidative stress, and are unable to sustain survival in a rich ozone/oxygen milieu.

Insects and Protozoans Adversarial to Hemp Cultures

Dozens of insect species have predilection for hemp plants. Not only do many insects pose a direct mechanical danger to plant integrity, but they also carry disease vectors such as fungi, bacteria and viruses. Common insect species include spider mites, aphids, thrips, sclarid flies, white flies and mealy bugs.

Ambient ozone/oxygen gaseous mixtures are inimical to all these insect parasites. While each species has its own LD50, given proper ozone concentrations and time of exposure, complete insect eradication can be reliably achieved.

Protozoan organisms disrupted by ozone include Giardia, Cryptosporidium, and free-living amoebas, namely Acanthamoeba, Hartmonella, and Negleria. Ozone/oxygen mixtures can thus readily rid plant cultures of the insects that plague them.

Protozoan species disrupted by ozone include Giardia, Cryptosporidium, and free-living amoebas, namely Acanthamoeba, Hartmonella, and Negleria. Spores of Bacillus cereus and Bacillus megaterium were susceptible to ozone. Several authors have demonstrated ozone's capacity to penetrate through the walls of Giardia cysts causing structural damage, and their demise.

Pesticides, Herbicides, Fungicides

Agents that inactivate plant fungi, pathogenic bacteria and viruses, and insects are all, to some extent, biological poisons. Herbicides to counter invasive plants, fungicides, bactericides, insecticides and other plant antimicrobials have been widely used on cannabis crop cultivations but cannot be applied to the cultivation of medicinal cannabis. Such agents as auxins, biopesticides, copper, cytokinins, giberellins, petroleum oils, phosphorous acid, pyrethrins, soaps and sulfur, among others, are all proscribed in cannabis cultivation destined for health care. All these agents, or their breakdown products, remain as permanent toxic pollutants in plants and their nutrient base.

This invention attempts to solve this problem by offering an apparatus and a method of pathogen decontamination that avoids any and all traces of toxic residue.

Carbon Dioxide in Plant Physiology

Carbon dioxide, CO2 is a natural element in the earth's atmosphere that plays a fundamental role in the life and welfare of our biosphere. Plants depend on its presence as they use the carbon in carbon dioxide by combining it with water (H2O), with the energy of UV radiation, to produce sugars, carbohydrates, and oxygen.

The concentration of CO2 has been rising in the past decades, now attaining some 400 parts per million (ppm). Increasing the CO2 content of ambient air, in moderation, increases plant growth. Estimated is that a 30% increase in ambient carbon dioxide—in the order of 100 ppm to 150 ppm—is optimal to fuel a 30% in growth. Beyond that, there are negative returns as plants, in auto-regulation, narrow their stomata—the openings in their leaves' undersides that permit gaseous exchanges, thus restricting gas exchange. Higher CO2 levels then begin to disrupt plant enzymatic functions.

In this invention, the upper compartment, sealed from the middle compartment by a membrane, allows the introduction of CO2 via a carbon dioxide generator. The CO2 concentration in this upper (foliage) compartment is auto-regulated to desired levels via servomechanisms involving CO2 analyzers with feedback to the generator, and to fans. Since temperature and humidity are important factors in CO2 utilization, temperature and humidity sensors form an integral part of the upper foliage growth compartment as described herein.

Oxygen and Ozone

The oxygen atom exists in nature in several forms: (1) as a free atomic particle (0), it is highly reactive and unstable. (2) oxygen (02), its most common and stable form, is colorless as a gas and pale blue as a liquid. (3) ozone (03), has a molecular weight of 48, a density one and a half times that of oxygen, and contains a large excess of energy in its molecule (03⇒3/2 02+143 KJ/mole). It has a bond angle of 127±3, is magnetic, resonates among several forms, is distinctly blue as a gas, and dark blue as a solid. (4) 04 is a very unstable, rare, nonmagnetic pale blue gas, which readily breaks down into two molecules of oxygen.

Ozone, an allotropic form of oxygen, contains a large excess of energy that can destabilize microbial defenses. Ozone is a powerful oxidant, surpassed in this regard only by fluorine. Exposing ozone to organic molecules containing double or triple bonds yields many complex and as yet incompletely configured transitional compounds (i.e. zwitterions, molozonides, cyclic ozonides), which may be hydrolysed, oxidized, reduced, or thermally decomposed to a variety of substances, chiefly aldehydes, ketones, acids, and alcohols. Ozone also reacts with saturated hydrocarbons, amines, sulfhydryl groups, and aromatic compounds. These properties are responsible for ozone's ability to destroy a wide spectrum of pathogens.

Ozone in Plant Physiology

Although some experiments have shown that minuscule ozone concentrations in the ambient gas milieu of plants can enhance their growth, most research points to ozone's inhibitory actions, especially in higher concentrations.

This ozone toxicity to plants' metabolism is the basis for using a two-chamber approach to separate the carbon dioxide foliage milieu from the middle disinfection ozone/oxygen compartment.

### Addition of Reactive Oxygen Species (ROS) and Nitrogen Reactive Species (NRS)

Gaseous compounds can be added to either the growth chamber to enhance plant development, or to the middle disinfection chamber to bolster antimicrobial efficacy. In the foliage chamber, the addition of minuscule concentrations of Reactive Oxygen Species (ROS), and Nitrogen Reactive Species (NRS), have promising potential.

### Ozone/Oxygen Disinfection of the Harvest, or of Other Herbs and Spices

Studies have shown that dried herbs and spices are often contaminated with pathogens that continue to be viable once they encounter a favorable milieu. This can pose a problem for human health. Herewith proposed, as an extension of the ozone/oxygen disinfection compartment, is an auxiliary chamber used for the eradication of fungi, bacteria, viruses, or insect and protozoan parasites present on the finished product. It is, in essence, a supplemental quality production process.

The harvested foliage can be placed in the Auxiliary chamber that may be fed by the same ozone generator that supplies the middle disinfection compartment. Or, alternatively, it may have a separate ozone/oxygen source.

### Detecting the Emergence of Pathogens in the Growth Chamber, and the Disinfection Compartment

Previous art (Sunnen, U.S. Pat. No. 6,073,627, which is incorporated herein in its entirety), attempted to address this issue in the treatment of infected wounds in humans and animals. This art described an ozone generator that delivered an ozone/oxygen mixture into a treatment envelope encasing the patient's lesion. The same principles apply in relation to plant growth.

The present invention incorporates an addition, namely sensors capable of detecting gases such as methane, emitted by pathogenic fungi and bacteria affecting plants under cultivation. Pathogens emit a spectrum of noxious byproducts, such as methane, indoles and skatoles. These can be detected via specialized chemical sensors that are placed in either the upper foliage, or the middle disinfection chambers. Signals from these sensors provide warning that invite adaptive responses in milieu conditions.

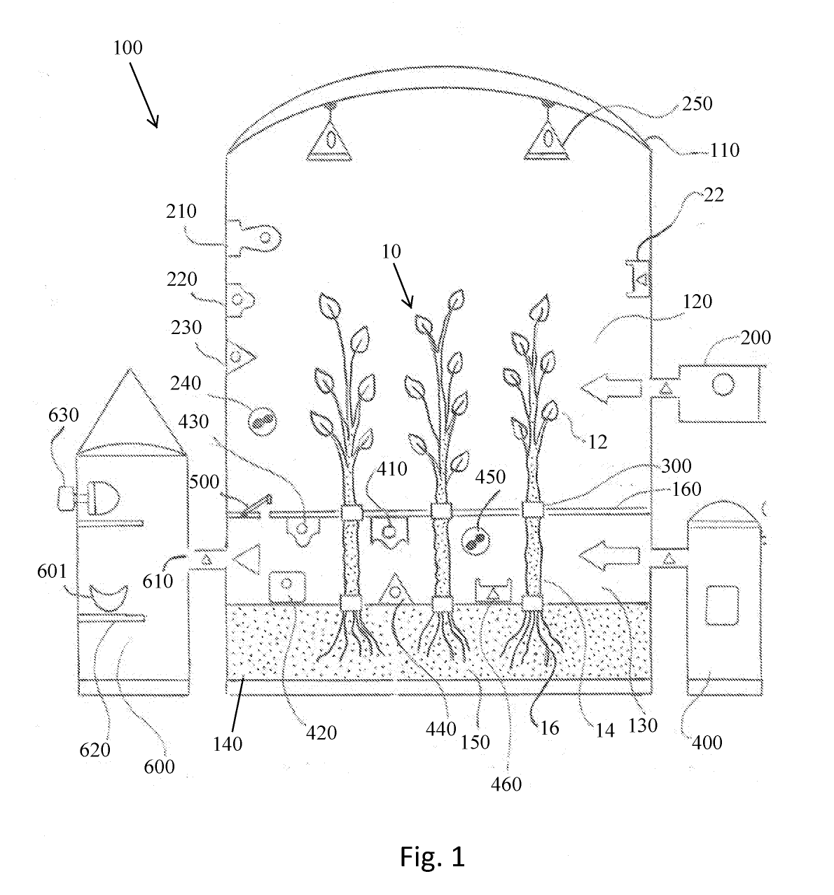

FIG. 1 shows an exemplary three-compartment configuration of a comprehensive plant growth and disinfection system 100. The system 100 is formed generally of an enclosure (housing) 110 that defines the inner confines of the system and allows for connections to other equipment. It will be appreciated that the size and shape of the housing 110 can vary in part depending upon the number and size of plants that are intended for placement within the housing 110. Any number of suitable materials can be used to construct the housing 110 including but not limited to plastics and glass, etc. The housing 110 can be formed of a transparent material to allow passage of light; however, as described herein, the housing 110 can include grow lights which can be a primary light source for the plants.

The housing 110 is also configured to attach to an irrigation system that provides controlled delivery of water to the plants. The housing 110 generally consists of a top wall, an opposite floor and side walls. It will also be appreciated that the floor can be formed of a different material compared to the top wall (ceiling) and the side walls.

As previously mentioned, within the housing 110, there are a plurality of compartments. For example, there is a first compartment (region) 120 (which can be referred to as an upper foliage compartment) and a second compartment (region) 130 (which can be referred to as a disinfection compartment). A lower portion 140 of the second compartment 130 can be thought of as being another distinct region (third region) of the system 100 and can be referred to a nutrient medium region. In the illustrated embodiment, this lower region of the second compartment 130 can itself be a third compartment that is separated from the second compartment 130 as described herein.

As described below, the first compartment 120 and second compartment 130 are physically separated from one another, while, in one embodiment, the third compartment 140 can be thought of as being a lower (bottom) region of the second compartment 130 There can be no physically separation between the second compartment 120 and the third region 130 since the third region is a lower portion of the second compartment 130. The interface between the second compartment 120 and the third region 130 is the top surface of nutrient medium (soil) 150 that is disposed within the lower portion of the second compartment 120 along the floor of the housing 110. Alternatively, as shown, there can be a physical separation from this third compartment and the second compartment 130.

The separation of the first compartment 120 (upper foliage compartment) from the second compartment 130 (disinfection compartment) is an important aspect of the present invention since it separates the different fluids (e.g., gases) that are introduced into these two compartments 120, 130. The separation can be thus be achieved by a membrane 160. Any number of types of membranes 160 can be used so long as the membrane 160 is impervious to the types of fluids introduced into the two compartments 120, 130 so as to serve as a fluid barrier between the two compartments 120, 130. For example, the membrane 160 can be formed of a suitable polymer, such an ozone-resistant material including but not limited to a silicone material and polyethylene material. and can be in the form of a flexible polymer film that extends across the inside of the housing 110 and is coupled to the side walls thereof. Alternatively, the membrane 160 can be formed of a more rigid structure that is coupled along its periphery to the side walls of the housing 110.

In the event that the second and third compartments are physically separated, a membrane, such as membrane 160, or the like can be used.

The membrane 160 can have a plurality of discrete perforated areas which can be selectively ruptured to define a passageway through the membrane 160 to allow passage of one plant from the second compartment 130 to the first compartment 120. For example, the membrane 160 can have an array of preformed perforated holes to allow the user to select which holes to open by rupturing the perforated area. Alternatively, the user can manually cut openings in the membrane 160.

As is known, a traditional plant 10 has a number of distinct parts including but not limited to upper foliage (leaves) 12 which typically sprouts from branches, a stem (trunk) 14 from which the branches/foliage depend, and roots 16. As shown in FIG. 1, the roots 16 are anchored within the nutrient medium 150, while most of the stem 14 is located above the top surface of the nutrient medium 150 and the upper foliage 12 is likewise located above the top surface of the nutrient medium 150. As discussed herein, the nutrient medium can be soil disposed along the floor of the housing 110 or it can be an aqueous medium (water) that can be contained along the floor and side walls or can be contained in a separate pool or vessel that is disposed along the floor of the housing 110.

In accordance with the present invention, the first compartment 120 (upper foliage compartment) encompasses the plant foliage 12 and typically, an upper portion of the stem 14, the second compartment 130 housing the plant stem 14 and the roots 16 once again are contained in the nutrient medium 150. As shown, the size (area/volume) of the first compartment 120 can vary from the size of the second compartment 130 and typically, the first compartment 120 has a greater size relative to the second compartment 130 to allow for growth of the plant 10.

As previously mentioned, the first compartment 120 provides an environment in which plant growth is facilitated.

The upper foliage compartment (first compartment) 120 is supplied with carbon dioxide from a carbon dioxide source 200, such as the illustrated carbon dioxide generator which is disposed external to the housing 110. The housing 110 includes a port or fitting to which the carbon dioxide generator 200 is attached and includes a valve that is identified by the triangular symbol and is controlled to control the flow rate of the carbon dioxide. The port can thus be a sealed opening formed in one of the side walls and any number of different techniques can be used to seal the generator 200 to the housing 110, such as certain coupling members, etc. As described below, the generator 200 is in communication with a master controller that allows for precise control over the generator 200, such as flow rate, on/off, etc.

In order to provide an optimal growing environment, a number of sensors and other operable parts are provided to control the growing environment and more particularly, to manage the components of the gas milieu. For example, a plurality of servomechanism (servos) can be provided and as is known, a servo is an electromagnetic device that converts electricity into precise controlled motion by use of negative feedback mechanisms. For example, the first compartment 120 can include a CO₂ analyzer (carbon dioxide sensor) 210 that is coupled to the housing 110 within the first compartment 120. For example, one or more CO₂ analyzers (sensors) 210 can be provided in the first compartment 120 and are used to regulate optimal growth acceleration. Traditionally, carbon dioxide sensors 210 are based on infrared light absorption technology. Carbon dioxide sensors 210, industrial and portable, are commercially available. Examples of suitable carbon dioxide sensors 210 include, but are not limited to, Honeywell Model IAQ or Telfair Model T7001. Each carbon dioxide sensor 210 detects the carbon dioxide content (level) within the first compartment 120.

A humidity sensor 220 and a temperature sensor 230 are also provided and are located within the first compartment 120, such as along one side wall thereof. The humidity sensor 220 can be any number of commercially available sensors that are designed to detect the level of humidity in the first compartment 120 and similarly, the temperature sensor 230 is a sensor which detects the temperature within the first compartment 120.

A fan 240 is also provided and is operable to direct air within the first compartment 120 and in particular to mix the gas milieu within the first compartment 120. The fan 240 can be attached to one of the side walls or can be suspended from the top wall.

As described below, each of the carbon dioxide sensor 210, humidity sensor 220 and temperature sensor 230 and the fan 240 are in communication with the master controller to allow for precise control and feedback.

One or more UV sources 250 are installed in the first compartment 120 to provide proper UV radiation. The UV sources 240 can be in the form of lights that are suspended from the top wall (ceiling).

Additionally, within the first compartment 120, a pathogen gas sensor 260 detects the presence of gases emitted by fungi or bacteria. As with the other sensors, the pathogen gas sensor 260 can be coupled to the side wall. For example, one or more methane sensors can be placed in the first compartment 120 (as well as also in the second compartment 130). Methane detection may be based on infrared, catalytic bead, or solid-state semiconductor technologies. Examples of suitable devices include, but are not limited to, Industrial Scientific Inc., Radius BZ1, and Sierra Monitor Model 5100. Other microbially generated gases may include hydrogen and hydrogen sulfides for which many detectors are commercially available. As with the other sensors, the pathogen gas sensor 260 is in communication with the master controller.

In addition, one or more ozone sensors can be placed in the first compartment (such as being mounted on one or more walls) and are needed in case microbial infestations threaten and shock treatment (as described herein) is prescribed. Thus, if shock treatment is implemented and ozone is delivered into the first compartment from the second compartment, then the level of ozone in the first compartment can be monitored and

The second compartment 130 (the disinfection compartment) contains the plant stems or trunks 14 which pass through the membrane 160 and into the upper foliage chamber (first compartment) 120, fitted with a hermetic expandable sleeve 300. The hermetic expandable sleeve 300 is configured to sealingly contact and surround the stem (trunk) 14 and the opening formed in the membrane 160. As mentioned, for each plant 10, the membrane 10 includes an opening into which the sleeve 300 is inserted. The hermetic expandable sleeve 300 can be formed of any number of suitable elastic materials, such as elastic polymers. The sleeve 300 also can help hold the plant 10 upright in place since the sleeve 300 is anchored in place within the membrane 160.

It will be appreciated that as the plant grows and the stem becomes wider, the expandable nature of the sleeve 300 accommodates such growth; however, at all times, due to the elastic nature of the sleeve 300 a compressive force is applied to the plant from the sleeve 300 to ensure a snug, sealed fit between the sleeve 300 and the plant. The membrane 160 itself can be formed of a similar or identical expandable material, such as a rubber film or polymer film that can likewise locally expand about an opening formed therethrough to permit passage of the plant 10.

The sleeve allowing the plant stems or trunks to access the upper foliage compartment forms an integral part of the dividing membrane, and is made of the same or similar ozone-resistant materials. It has the capacity to expand as said stems and trunks grow in their circumference. FIG. 1 also shows that a set of sleeves 300 can be used at the interface between the soil (nutrient medium) and the second compartment 120 and in particular, the sleeve 300 are around the stems 14 of the plants 10 at said interface.

In one embodiment, the membrane 160 is an elastic structure (it can readily stretch and contract, etc.) and the sleeve can be in the form of an integral reinforced part of the membrane 160. The sleeve can also be constructed such that it in its unused state, the sleeve is closed so as to prevent gas exchanges between the two compartments. It can, however, be opened to allow the upwardly moving shoots to be guided through. Once through, the sleeve opening widens as the stems and trunks expand in width. Thus, the sleeve can be formed of a reinforced material that can be different than the sleeve that can be positioned between open and closed positions due to its inherent elasticity that allows free expansion and contraction. For example, the sleeve can be formed of a material having greater elasticity relative to the surrounding membrane material. The sleeve and membrane can be made integral as by a common molding operation. In yet another embodiment, the sleeves are eliminated and instead the elastic membrane has perforated areas that can be ruptured to define an expandable/contractable opening through which the stem of the plant can pass. The inherent elastic nature of the membrane will cause the membrane to seal against the stem since the perforated opening is much smaller than the width of the stem.

This second compartment 130 (disinfection compartment) is supplied with selected concentrations of ozone to oxygen. A source of ozone is provided and can be in the form of an ozone generator 400 is fed by an oxygen supply 402. The housing 110 includes a port or fitting to which the ozone generator 400 is attached and includes a valve that is identified by the triangular symbol and is controlled to control the flow rate of the ozone. The port can thus be a sealed opening formed in one of the side walls and any number of different techniques can be used to seal the generator 400 to the housing 110, such as certain coupling members, etc. As described below, the generator 400 is in communication with a master controller that allows for precise control over the generator 200, such as flow rate, on/off, etc.

In order to provide an optimal disinfecting environment, a number of sensors and other operable parts are provided to control the growing environment and more particularly, to manage the components of the gas milieu within the second compartment 130. For example, a plurality of servomechanism (servos) can be provided. For example, servomechanisms maintain a desired milieu for plant disinfection and can include an ozone analyzer (ozone sensor) 410 which is configured to detect the level (amount) of ozone in the second compartment 130. Ozone sensors in air are based on the property of ozone for absorbing ultraviolet light. Ambient gas (such as the gas in the second compartment 130) is exposed to light with a wavelength of approximately 254 nanometers and, correcting for barometric pressure and temperature, the ozone concentration is determined within the targeted area, such as the second compartment 130. Ozone air analyzers and monitors are commercially available such as the Teledyne Instruments Model 450H, the ECO Sensor Model D03, or the Oxidative Technologies F12-D. Ozone sensors in water are widely commercially available and include the Eco-Sensor Model UV106-W, or the ATI Analytical Technologies Model Q46H/64.

Additional sensors or parts that are located within the second compartment 130 can include an ozone destructor 420 which is configured to convert ozone into oxygen rapidly and without emitting any toxic gases, such as carbon monoxide or carbon dioxide. Ozone destructors accelerate the conversion of ozone to oxygen. Excess ozone/oxygen gases that may need to exit the compartments need to be rendered safe to health, as ozone can be a respiratory irritant. Ozone/oxygen gases are passed through ozone destructors which, by means of heat and/or catalysts, insure that gas outflow is all oxygen. Catalysts are usually proprietary but most contain metals such as magnesium. Examples are Ozone Solutions Inc., Model NT-70, and Innovateck Model KVME.

A humidity sensor 430 and a temperature sensor 440 are also provided and are located within the second compartment 130, such as along the underside of the membrane 160 or along the top surface of the nutrient medium (soil). The humidity sensor 220 can be any number of commercially available sensors that are designed to detect the level of humidity in the first compartment 120 and similarly, the temperature sensor 230 is a sensor which detects the temperature within the first compartment 120.

A fan 450 is provided to homogenize the gas milieu within the second compartment 130. Additionally, a pathogen gas sensor 460 can be provided to detect the presence of gases emitted by bacteria or fungi. For example, one or more methane sensors can be placed in the second compartment 130. Methane detection may be based on infrared, catalytic bead, or solid-state semiconductor technologies. Exemplary methane detection devices are disclosed herein.

Shock Treatment

At times, when the first and second compartments 120, 130 need to be “shocked” because of pathogen growth, the first and second compartments 120, 130 can be infused with ozone/oxygen via an intake valve 500 that provides selective communication between the second compartment 130 and the first compartment 120. Any number of different types of valves can be used so long as the valve can be controllably opened and closed to permit selective fluid communication between the two compartments 120, 130 and can be either manually operated by a user or can be operated by a master controller that sends a signal to the valve (electro-mechanical valve or causes movement of a linkage to open and close the valve, etc.). The valve 500 can be disposed within the membrane 160, such as along the membrane 160 near one side wall. Opening of the valve 500 allows the ozone from the second compartment 130 to flow into the first compartment 120 to allow the disinfecting of the foliage and upper stem by the ozone (gas milieu). The arrow shown in the second compartment 130 shows the flow direction into the auxiliary unit described below.

All the above components (parts) are encased in a hermetic chamber (housing 110) that may house a few, or thousands of plants.

Auxiliary Unit

In yet another aspect, an auxiliary unit 600 is selectively in fluid communication with the second compartment 130 and located external to the main housing 110. As illustrated, a conduit (passageway/tube) is provided between the main housing 110 and the auxiliary unit 600 and in particular, between the second compartment 130 and the auxiliary unit 600.

The gas content of the auxiliary unit 600 is derived from the disinfection chamber (second compartment) 130 via an intake valve 610, or from a separate source, provides a final anti-microbial process. Within the auxiliary unit 600, one or more shelves 620 are provided for holding recipients 601 containing the harvest, or herbs and spices from other provenance. Herbs and spices that may be treated via this method include but are not limited to: turmeric, paprika, curries, cinnamon, pepper, basil, and cannabis. In other words, the recipients 601 comprise mature, cut plants that are drying or otherwise being treated.

Treatment of these products (recipients 601) within the auxiliary unit 600 by maximal exposure to ozone/oxygen is proposed via a motorized rotating drum 630 that serves to separate and disperse herbs and spices, thus making the apposition of ozone/oxygen mixtures more uniform and efficient in their anti-microbial action within the auxiliary unit 600.

Computer Implemented System and Method

As described herein, the system 100 can be part of a computer implemented system to allow for sensor feedback and control of the operable parts, such as the valves and fans.

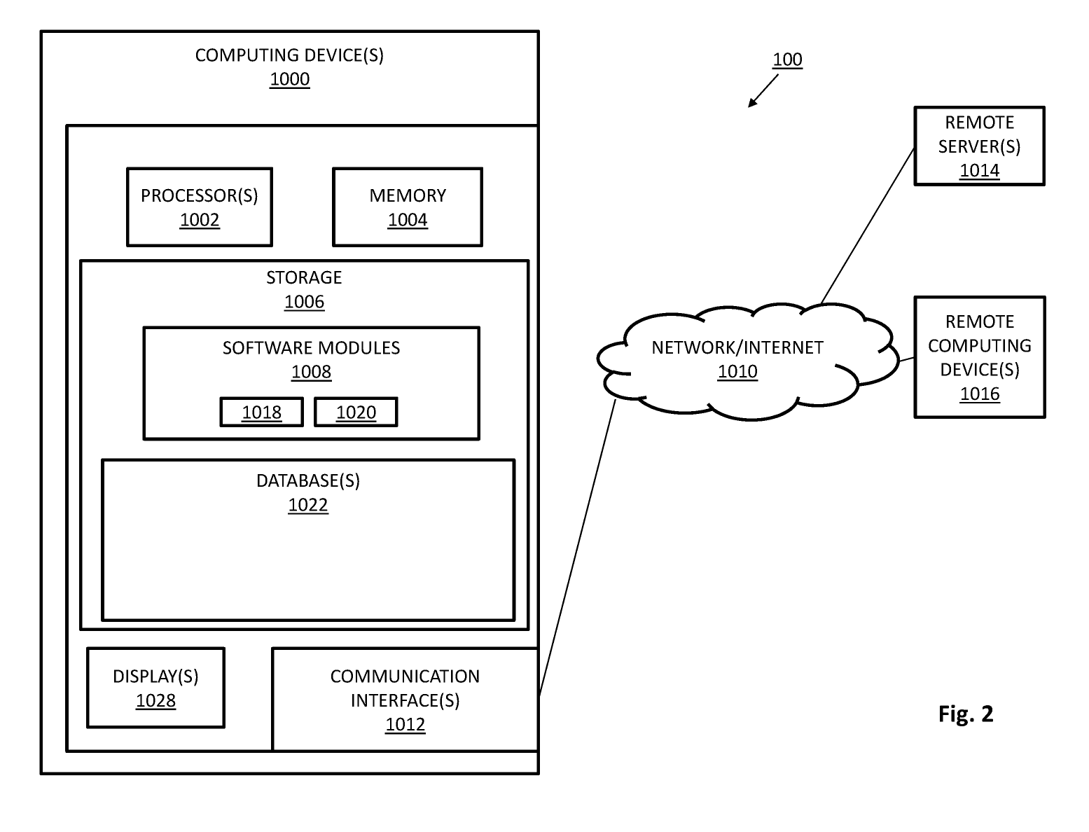

As shown in FIG. 2, the system 100 can include one or more computing devices 1000. The computing device(s) 1000 can be in the form of a personal computer, a mobile device, a tablet, a work pad, etc. FIG. 2 is a high-level diagram illustrating an exemplary configuration of the computer implemented system 100. The system 100 includes one or more computing devices 1000. In one arrangement, computing device(s) 1000 a can be a personal computer or server. In other implementations, computing device(s) 1000 can be a tablet computer, a laptop computer, or a mobile device/smartphone or retail kiosk, for example. It should be understood that computing device(s) 1000 of the system 100 can be practically any computing device and/or data processing apparatus capable of embodying the systems and/or methods described herein. As understood by those of skill in the art, the computing device 1000 can comprise a host machine that runs one or more of the modules in a virtualized environment, and, as such, can be scaled or executed on a variety of machines. In one implementation, the computer implemented system is configured and includes software that communicates with a design creator, a seller and an end user, to allow the end user to upload a proposed design that then is processed by the other parties.

The computing device 1000 includes one or more hardware processors 1002 and at least one memory 1004. Processor(s) 1002 serve to execute instructions for software that can be loaded into memory 1004. The computing device 1000 can also include storage 1006. Memory 1004 and/or storage 1006 are preferably accessible by processor(s) 1002, thereby enabling processor(s) 1002 to receive and execute instructions stored on memory 1004 and/or on storage 1006. Memory 1004 can be, for instance, at least one random access memory (RAM) or any other suitable volatile or non-volatile computer readable storage medium. In addition, memory 1004 can be fixed or removable. Storage 1006 can take various forms, depending on the particular implementation. For example, storage 1006 can contain one or more components or devices such as a hard drive, a flash memory, a rewritable optical disk, a rewritable magnetic tape, or some combination of the above. Storage 1006 can also be fixed or removable.

One or more software modules 1008 are encoded in storage 1006 and/or in memory 1004. The software modules 1008 can comprise one or more software programs or applications having computer program code or a set of instructions executed in processor 1002. Such computer program code or instructions for carrying out operations for aspects of the systems and methods disclosed herein can be written in any combination of one or more programming languages, including an object oriented programming language, such as, PHP, C#, VB, Ruby, Java, Smalltalk, C++, Python, and JavaScript, or the like. The program code can execute entirely on computing device 1000, partly on computing device 1000, as a stand-alone software package, partly on computing device 1000 and partly on a remote computer/device, or entirely on the remote computer/device or server. In the latter scenario, the remote computer can be connected to computing device 1000 through any type of network, including a local area network (LAN) or a wide area network (WAN), or the connection can be made to an external computer (for example, through the Network/Internet 2210 using an Internet Service Provider).

One or more software modules 1008, including program code/instructions, are located in a functional form on one or more computer readable storage devices (such as memory 1004 and/or storage 1006) that can be selectively removable. The software modules 1008 can be loaded onto or transferred to computing device 1000 for execution by processor(s) 1002. It should be understood that in some illustrative embodiments, one or more of software modules 1008 can be downloaded over a network to storage 1006 via one or more network interfaces 1012 from another device or system for use within the computing device 1000. For instance, program code stored in a computer readable storage device in remote server(s) 1014 or remote computing device(s) 1016 can be downloaded over Network/Internet 1010 from the server(s) 1014 or device(s) 1016 to the computing device 1000.

Preferably, included among the software modules 1008 is a first compartment monitoring application 1018 and a second compartment monitoring application 1020, which are executed by processor 1002. During execution of the software modules 1008, and applications 1018, 1020, the processor 1002 configures the computing device 1000 to perform various operations relating to maintaining desired operating conditions, such as gas concentrations in the two compartments.

With continued reference to FIG. 2, one or more databases 1022 are also preferably stored in storage 1006. As will be described in greater detail below, database(s) 1022 can contain and/or maintain various data items and elements that are utilized throughout the various operations of system 1000. It should be noted that although database(s) 1022 is depicted as being configured locally to computing device 1000, in certain implementations database(s) 1022 and/or various of the data elements stored therein can be located remotely (such as on a remote server 1014 or remote computing device 1016) and connected to computing device 1000 through Network/Internet 1010, in a manner known to those having ordinary skill in the art.

As also referenced above, network interface(s) 1012 can be any interface that enables communication between the computing device 1000 and external devices, machines and/or elements. Preferably, network interface(s) 1012 include, but are not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting computing device 1000 to other computing devices and/or communication networks such as private networks and the Internet 1010. Such connections can include a wired connection or a wireless connection (e.g. using the IEEE 802.11 standard), though it should be understood that communication interface(s) can be practically any interface that enables communication to/from the computing device 1000.

A display 1028 is provided for displaying selected information, such as the types of fluids being used, flow rates and readings from the sensors, as well as various operating modes, such as normal mode or spike mode.

As mentioned, each of the sensors and the working components, such as the fans, and the operable valves can be in communication with a processor (master controller) that is part of the computer implemented system described above. In this manner, the flow of carbon diosize and ozone are monitored and fully controlled so that the desired gas milieu in each of the first compartment 120 and the second compartment 130 are realized. In addition, in the event of a shock treatment being needed, the valve (e.g., flap valve or one-way valve, etc.) between the two compartments 120, 130 can be opened to permit ozone from the second compartment 130 to flow into the first compartment 120. In addition, alerts (audio/visual) can be generated such as when a pathogen level exceeds a threshold level or when other conditions are observed.

The present invention thus provide a system and method having one or more of the following characteristics:
1. This protection targets not only fungi which account for a majority of plant diseases, but also bacteria, viruses and many parasites, such as protozoans and insects.
2. The process of plant growth and concomitant plant disinfection is devoid of any chemical and toxic residues. All agents used in this process revert to natural constituents, namely oxygen, water, carbon dioxide and nitrogen, all elements found in our natural environment.
3. The system is especially aimed at plant cultures that require the end products to embody the highest purity and quality, as exampled by any one of many medicinal plants. Medicinal plants include, but are not limited to willow, cinchona, and medical cannabis.
4. The system aims to prevent the emergence of plant pathogens, namely fungi, bacteria, viruses and parasites, thus acting as a preventive treatment modality.
5. The growing medium treated by this disinfection process may consist of soil, or it may be hydroponic.
6. A system of plant culture where the ambient gas medium is segregated into two compartments: An upper compartment containing the plant foliage; and a lower compartment encompassing the plant stems and trunks.
7. The undermost compartment contains the growing medium, which may be soil-based, or hydroponic. It contains the plant root systems. The milieu of this compartment is carefully monitored. If an aqueous medium, dissolved gases such as oxygen and ozone are monitored.
8. The upper foliage compartment encloses an environment controlled relative to light, temperature, airflow, and humidity. It also incorporates a system providing carbon dioxide, CO2, which contributes to optimal plant growth. Each of these parameters is kept under optimal conditions via servomechanisms.
9. Depending upon plant type, the CO2 levels in the foliage chamber may vary from 0% to 50% above the normal atmospheric levels, currently gauged at approximately 400 parts per million (400 ppm). Thus, the CO2 level in the upper chamber may range from 400 ppm to 600 ppm.
10. The upper foliage compartment may also contain other plant growth-enhancing gases or substances, such as selected oxygen reactive species (ROS), or nitrogen reactive species (NRS). Under selected circumstances, various reactive oxygen species (ROS)—such as any of the peroxides—may be added; or nitrogen reactive species (NRS), all designed to further enhance antimicrobial capacities. Selective humidification of this compartment is an important added component, as water chemically interacts with oxidative gases to produce anti-microbial transitional compounds, such as peroxide species.
11. The membrane separating the upper from the lower compartments is made of ozone-resistant materials such as, but not limited to, silicones and polyethelenes.
12. Plant stems and trunks pass individually through the membrane. The membrane fits snuggly around the plant stems and trunks by means of an expendable elastic collar. The gaseous milieu of the upper and middle chambers is thus prevented from mixing.
13. The middle compartment contains a controlled oxygen/ozone mixture, supplied by an ozone generator, aiming to thwart, or treat, the proliferation of fungi, bacteria, viruses and parasites. The optimal proportions of ozone to oxygen are predicated upon plant type, and are regulated by servomechanisms that recruit the ozone generator, ozone analyzers, and ozone destructors.
14. Ozone is an effective antagonist to the viability of an enormous range of pathogenic organisms. In this regard, ozone cannot be equaled. It is effective in inactivating anaerobic and aerobic bacterial organisms and a wide swath of viral families—lipid as well as non-lipid enveloped,—and, fungal and protozoan pathogens. To replicate this disinfecting action on plants afflicted with a variety of pathogens, the conditions in question would have to be treated with complex conglomeration of pesticides, all purveyors of toxic residues.
15. In this invention, ozone is generated from an oxygen source. Because this is not a medical application, the oxygen may come from an industrial source, or from an oxygen concentrator. Industrial oxygen may reach purity levels of 99% or greater.
16. Mixtures of oxygen/ozone need to be applied in precise concentrations because too low concentrations will fail to achieve proper antimicrobial action, while those that are too high may alter flavors via oxidation. Optimal concentrations need to be applied for proper spans of time so that adequate organism inactivation will be achieved.
17. The concentration of ozone relative to oxygen in this gaseous mixture ranges, according to plant species under cultivation, from 0.0% to 5% by volume relative to the volume of the second compartment. A 5% by volume ozone concentration is sufficient to inactivate all plant pathogens.
18. Middle chamber ozone concentrations are regulated by ozone concentration analyzers, which modulate the ozone generator's output—thus increasing, or decreasing ozone concentration, as well as by an ozone destructor.
19. The middle disinfection compartment may also contain other gases or substances, such as selected oxygen reactive species (ROS), or nitrogen reactive species (NRS), designed to enhance anti-microbial effects. Selective humidification of this compartment is an important added component, as water chemically interacts with these gases to produce anti-microbial transitional compounds, such as peroxide species.
20. The present invention incorporates an addition, namely sensors capable of detecting gases such as methane, emitted by pathogenic bacteria affecting plants under cultivation and treatment. Pathogens emit a spectrum of noxious byproducts, such as methane, indoles and skatoles. These can be detected via specialized chemical sensors that are placed in either the upper or middle chambers. Signals from these sensors provide warning that invite adaptive responses in milieu conditions.
21. Shock treatment. At times, in situations that resemble the treatment of swimming pools that become overrun with pathogens and are treated with a one-time massive dose of chlorine, the upper foliage compartment can be “shocked” when it is determined that invading organisms are threatening. In this scenario, the foliage chamber is infused with ozone/oxygen for prescribed time frames, via the opening of a communication valve in the membrane.
22. Connected to the middle chamber is an auxiliary chamber that can receive its ozone/oxygen mixtures. Once harvested, the crop foliage may be placed in this chamber to insure that all pathogens have indeed been deactivated, thus respecting the quality of the finished product.
23. The auxiliary chamber may also be used for the disinfection of a spectrum of herbs and spices, fresh or dried. Examples of herbs and spices candidates for the Auxiliary chamber include, but are not limited to, turmeric, paprika, curries, cinnamon, pepper, basil and cannabis.
24. Several sensors provide data to microprocessors that integrate the workings of this system. Sensors are placed in all three compartments of this plant growth and disinfection system.
25. In the upper foliage compartment are placed carbon dioxide, oxygen, ozone, and microbial gas sensors. Ambient CO2 sensors are needed to regulate optimal growth acceleration. Ozone sensors are needed in case microbial infestations threaten and shock treatment is prescribed. Microbial gases include methane and hydrogen, among others.
26. In the middle stem and plant trunk compartment are sensors that measure ozone concentrations so that concentrations optimal to microorganism inactivation are administered.
27. The lowest compartment (region) containing plant root systems which, if hydroponic, contains aqueous oxygen sensors and aqueous ozone sensors. Optimal oxygen concentrations provided to plant roots contribute to growth. Ozone sensors are also added because ozone may be provided to this compartment for microbial control, when infestations are detected in periodic analyses.
28. Carbon dioxide sensors are based on infrared light absorption technology. Sensors, industrial and portable, are commercially available. Examples include Honeywell Model IAQ or Telfair Model T7001.
29. Ozone sensors in air are based on the property of ozone for absorbing ultraviolet light. Ambient gas is exposed to light with a wavelength of approximately 254 nanometers and, correcting for barometric pressure and temperature, the ozone concentration is determined. Ozone air analyzers and monitors are commercially available such as the Teledyne Instruments Model 450H, the ECO Sensor Model D03, or the Oxidative Technologies F12-D.
30. Ozone sensors in water are widely commercially available and include the Eco-Sensor Model UV106-W, or the ATI Analytical Technologies Model Q46H/64.
31. Methane sensors are placed in both ambient gas chambers. Methane detection may be based on infrared, catalytic bead, or solid-state semiconductor technologies. Examples include the Industrial Scientific Inc., Radius BZ1, and the Sierra Monitor Model 5100. Other microbially generated gases may include hydrogen and hydrogen sulfides for which many detectors are commercially available.

The present application derives several principles from a patent that was granted to the current inventor as USPTO U.S. Pat. No. 6,073,627, “Apparatus for the application of ozone/oxygen for the treatment of external pathogenic conditions.” That patent contains data on ozone's properties relative to microorganisms, on methods of generation, and the use of ozone-resistant materials.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for a plant culture to promote plant growth while concomitantly providing microbial protection comprising:
a main housing having a hollow interior which is divided into a first compartment and a second compartment by a membrane that extends across the hollow interior of the main housing, the membrane providing a fluid barrier between the first compartment and the second compartment, the first compartment for receiving foliage of the plant and the second compartment for receiving a lower stem and roots of the plant;
one or more elastic sleeves disposed within corresponding one or more openings formed in the membrane for receiving the stem of the plant;
a first fluid source in selective communication with the first compartment for providing the first fluid to the first compartment, the first fluid being a fluid that promotes plant growth;
a second fluid source in selective communication with the second compartment for providing the second fluid to the second compartment, the second fluid being a fluid that renders plant pathogens inactive; and
a controllable valve positioned along the membrane for selectively communicating the second compartment to the first compartment.

2. The system of claim 1, wherein the first compartment comprises an upper region of the main housing and the second compartment comprises a lower region of the main housing and the membrane comprising a polymer film that is impervious to gases including carbon dioxide and ozone.

3. The system of claim 1, wherein the first fluid comprises carbon dioxide and the second fluid comprises ozone.

4. The system of claim 1, wherein the membrane is suspended above a floor of the main housing and is for placement above a top exposed surface of a nutrient medium.

5. The system of claim 1, wherein the first fluid source comprises a carbon dioxide generator that is connected to the main housing via a first port through which carbon dioxide can selectively enter the first compartment and wherein the second fluid sources comprises an ozone generator that is connected to the main housing via a second port through which ozone can selectively enter the second compartment.

6. The system of claim 1, wherein each sleeve is formed of an elastic material selected from the group consisting of a rubber and a polymer material, wherein a plurality of sleeves are sealingly fitted within openings formed in the membrane.

7. The system of claim 6, wherein the controllable valve is a mechanical valve that when opened by a signal received from a master controller defines an opening connecting the first and second compartments.

8. The system of claim 1, further including: (1) a first set of sensors that are disposed within the first compartment for monitoring conditions within the first compartment including a carbon dioxide sensor that measures a level of carbon dioxide in the first compartment, and (2) a second set of sensors that are disposed within the second compartment for monitoring conditions within the second compartment including an ozone sensor that measures a level of ozone in the second compartment.

9. The system of claim 8, wherein the first set of sensors further includes a humidity sensor, a temperature sensor and a pathogen sensor configured to detect a microbially generated gas.

10. The system of claim 9, wherein the pathogen sensor comprises one of: a methane sensor for detecting methane gas and a sensor for detecting hydrogen and hydrogen sulfides.

11. The system of claim 8, wherein the second set of sensors further includes a humidity sensor, a temperature sensor and a pathogen sensor configured to detect a microbially generated gas.

12. The system of claim 8, further including an ozone destructor disposed within the second compartment.

13. The system of claim 8, further including a master controller that is operatively coupled to and in communication with the first set of sensors, the second set of sensors, a first valve to control flow of the first fluid into the first compartment and a second valve to control flow of the second fluid into the second compartment and the controllable valve.

14. The system of claim 1, further including a first fan disposed within the first compartment for mixing a first gas milieu that forms in the first compartment and a second fan disposed within the second compartment for mixing a second gas milieu that forms in the second compartment.

15. The system of claim 1, further including an auxiliary unit for storing grow recipients that is in selective fluid communication with the second compartment via a conduit in which an auxiliary fluid flow valve is located and is configured to allow a controlled flow of ozone/oxygen from the second compartment into an interior of the auxiliary unit.

16. The system of claim 15, further including a rotating device disposed within the auxiliary unit to optimize exposure to ozone/oxygen and serves to separate and disperse the grow recipients, thus making an apposition of ozone/oxygen mixtures more uniform and efficient in their anti-microbial action within the auxiliary unit.

17. The system of claim 1, wherein CO2 levels in the first compartment are between 0% to 50% above a normal atmospheric level that is approximately 400 parts per million (400 ppm) and as a result the CO2 level in the first compartment is maintained within a range from about 400 ppm to about 600 ppm.

18. The system of claim 1, wherein the membrane is made of an ozone-resistant materials selected from the group consisting of a silicone material and a polyethylene material.

19. The system of claim 1, wherein the second fluid comprises ozone and a concentration of the ozone within the second compartment is maintained between about 0.0% to about 5% by volume.

20. A method for promoting plant growth while concomitantly providing microbial protection comprising the steps of:
placing one or more plants in a main housing that has a membrane that divides the main housing into a first compartment and a second compartment with upper foliage of each plant being located in the first compartment, while a lower stem or trunk and roots are located in the second compartment, the membrane being a barrier to prevent gas flow between the first compartment and the second compartment;
introducing carbon dioxide into the first compartment at a concentration that promotes plant growth; and
introducing ozone into the second compartment at a concentration that renders any plant pathogens inactive, the barrier serving to prevent ozone from flowing into the first compartment from the second compartment.

21. A system for a plant culture to promote plant growth while concomitantly providing microbial protection comprising:
a main housing having a hollow interior which is divided into a first compartment and a second compartment by an elastic membrane that extends across the hollow interior of the main housing, the elastic membrane providing a fluid barrier between the first compartment and the second compartment, the first compartment for receiving foliage of the plant and the second compartment for receiving a lower stem and roots of the plant, the elastic membrane having one or more perforated openings for receiving the stem of the plant and permit passage of the plant into the first compartment;
a first fluid source in selective communication with the first compartment for providing the first fluid to the first compartment, the first fluid being a fluid that promotes plant growth;
a second fluid source in selective communication with the second compartment for providing the second fluid to the second compartment, the second fluid being a fluid that renders plant pathogens inactive; and
a controllable valve positioned along the membrane for selectively communicating the second compartment to the first compartment.
